(19) United States
(12) Patent Application Publication
(10) Pub. No.: US 2003/0198519 A1
(43) Pub. Date: Oct. 23, 2003

(54) Repair of lined pipes

(75) Inventors: Mark Berkeley Fitzhardinge, Salter Point (AU); Stephen Reginald Brown, Alfred Cove (AU); William Alan Hodgkinson, Wilson (AU)

Correspondence Address: MERCHANT & GOULD PC, P.O. BOX 2903, MINNEAPOLIS, MN, 55402-0903, US

(73) Assignee: WATER CORPORATION, Leederville (AU)

(21) Appl. No.: 10/442,711

(22) Filed: May 20, 2003

Related U.S. Application Data
(63) Continuation of application No. 09/787,863, filed on May 25, 2001, now abandoned.
Application No. 09/787,863 is a 371 of international application No. PCT/AU99/00809, filed on Sep. 22, 1999.

(30) Foreign Application Priority Data
Sep. 22, 1998 (AU) PP 6092

(51) Int. Cl. F16L 55/16

(52) U.S. Cl. 405/184.1; 405/184.2; 138/98

(57) ABSTRACT

A method of selectively repairing the lining of a lined pipeline utilising a conveyance adapted to be receivable within and to travel through the pipeline. The conveyance consists of a plurality of vehicles comprising an inspection means, an excising means, a debris removal means and an application means. The method comprises: an identification step whereby the conveyance travels along the pipeline inspecting and locating damaged portions of the lining; an excising step whereby damaged portions of the lining identified from the inspection step are removed by the conveyance; a debris removal step whereby the conveyance travels along the pipeline to remove debris and/or water left in the pipeline by the excising step; and an application step whereby the conveyance travels along the pipeline and applies a fresh lining composition to replace the excised portions of lining removed by the excising step. The invention also relates in a conveyance for effecting the selective repair of the lining of a lined pipeline according to the method described above.

### FIELD OF THE INVENTION

This invention relates to a method of refurbishing a lined pipeline and means to facilitate such refurbishment.

Throughout this specification the term “lining composition” shall be taken as including any form of composition such as cement mortar, concrete, plastics materials (such as urethane or ethylene based materials), epoxy materials, paints or like compositions which are suitable for application to the internal surface of a pipeline for use as a protective lining.

### BACKGROUND

A particular application of the invention relates to the refurbishing of water pipelines which have been lined with a lining composition.

In regard to water pipelines it has been conventional practice to provide the pipelines with a cement lining in order to protect the internal face of the pipeline from corrosion. However, a significant difficulty arises with lined water pipelines when the lining deteriorates and the protection which is offered by the lining is reduced. In the past, in circumstances where the lining has become degraded or damaged, it has been conventional practice to remove from the pipeline the damaged length of pipeline and replace it by a section of new pipeline or alternatively to completely remove all of the existing lining and replace it with a fresh lining or alternatively patch repair the localised lining failure manually. Each of these exercises has proven to be unnecessarily expensive exercises.

However, it has been found that the existence of minor cracks or like physical damage to the lining need not necessarily be indicative that the lining is failing to provide its protection action since it has been found that the alkaline environment provided by the lining seems to provide a protective environment for the inner face of the pipeline. Furthermore, even after the chemical protection has been lost, the presence of a physical barrier which is provided by the degraded lining seems to delay the progress of corrosion of the pipe. Therefore it is only when the lining of the pipeline has been degraded such that it is unable to provide the desired chemical and physical protection of the pipeline that it becomes necessary to replace the lining. In addition it has been found that the degradation does not usually occur uniformly but is only localised at particular locations in the lining (even in pipelines of considerable age) and the degree of localisation of the damage or deterioration does not warrant the wholesale replacement of a length of pipeline or the wholesale refurbishment of the lining of the pipeline. Therefore the wholesale replacement of pipe or the lining can in many cases be unnecessary and, extremely wasteful.

It is an object of this invention to provide a means and a method whereby the cement lining of a pipeline can be selectively refurbished as required where such refurbishment can comprise the complete replacement of large sections of lining and/or partial refurbishment of patches of lining.

### DISCLOSURE OF THE INVENTION

Accordingly the invention resides in a method of selectively repairing the lining of a lined pipeline, said method comprising utilisation of a conveyance adapted to be receivable within the pipeline, said conveyance being adapted to be able to travel through the pipeline, said method further comprising introducing said conveyance into the pipeline, said conveyance comprising an inspection means, an excising means, a debris removal means and an application means, said method further comprising an identification step comprising causing the conveyance to travel along the length of the pipeline, inspecting the surface of the lining and identifying and locating damaged portions of the lining at locations along the pipeline, said method further comprising an excising step comprising moving said conveyance means along the pipeline and at the locations identified by the inspection excising the damaged portions of the lining from the pipeline, said method further comprising a debris removal step comprising causing said conveyance means to travel along said length of the pipeline to remove the debris left in the pipeline by the excising step, and said method comprising an application step comprising causing said conveyance means to travel along the said length of the pipeline and applying a fresh lining composition onto the lining to replace the excised portions of lining removed by the excising step.

According to a preferred feature of the invention said method further comprises cutting a length of pipe from the pipeline at a location to provide a gap in the pipeline at the location, locating a support tray between the opposed ends of the remaining pipeline to span the lower portion of the gap and to provide a continuation of the lower surface of the pipeline across the gap. According to a particular, embodiment of the invention the pipeline is above the ground at the location. According to an alternative form of the invention the pipeline is buried at the location and the method further comprises exposing the length of pipe at the location prior to the length of pipe being cut from the pipeline.

According to a preferred feature of the invention said conveyance means comprises a plurality of self propelled and self powered vehicles which comprise: at least one inspection vehicle for said inspection step; an excising vehicle for said excising step; at least one removal vehicle for said removal of debris step; and at least one application vehicle for said application step.

According to a preferred feature of the previous feature of the invention at least some of the vehicles are adapted to be operated remotely. According to one embodiment all of the vehicles are adapted to be operated remotely. According to an alternative embodiment at least one of the vehicles is adapted to be operated by an operator in-situ in the pipeline and incorporates controls operable by the operator to effect at least some of the operations of the vehicle. According to a feature of the alternative embodiment the at least one vehicle is provided with a support to enable the operator to be supported by the vehicle. According to an alternative feature of the embodiment the at least one vehicle is associated with an operator trolley which is coupled to the at least one vehicle wherein the operator trolley is provided with a support to enable the operator to be supported by the operator trolley. According to a particular form the operator trolley is provided with the controls.

According to a preferred feature of the invention said inspection step comprises causing the inspection vehicle to travel along the interior of the pipeline and during such travel inspecting the lining within the pipeline, identifying locations of damaged or deteriorated lining and maintaining a log recording the axial position of said location along the length of the pipeline, the radial location of the location around the pipeline, and the type of damage. According to one embodiment of the invention the inspection step is conducted remotely. According to a alternative embodiment the inspection step involves utilisation of an operator supported on the inspection vehicle, said operator being skilled in identifying the damaged or deteriorated portions of the lining, said identifying of damaged or deteriorated lining including the operator providing markings on the lining to indicate the locations.

According to a further preferred feature of the invention said excising step comprises utilisation of a remotely controlled nozzle connected to a source of high pressure fluid whereby said nozzle is able to be moved to direct a jet of said high pressure fluid, said remotely controlled nozzle being supported from the excising vehicle, said method causing the excising vehicle to travel along the interior of the pipeline and during such travel causing the nozzle to direct said jet of said high pressure fluid onto the damaged lining at the locations in order to remove the lining at said locations. According to one embodiment the excising vehicle is associated with a remote control station which is provided with a display means and controls to enable the remote operation of the vehicle and the nozzle from the control station by an operator.

According to a further preferred feature of the invention said debris removal step comprises causing a removal vehicle to travel along the interior of the pipeline and causing the removal vehicle to collect debris from the interior of the pipeline as it travels. According to one embodiment the removal step initially comprises causing a primary removal vehicle to travel along the interior of the pipeline, scooping large items from the pipeline as it travels along the pipeline and conveying the items into a hopper associated with the primary removal vehicle. According to a further preferred feature of the embodiment said debris removal step further comprises causing a secondary removal vehicle to travel along the interior of the pipeline and causing the secondary removal vehicle to brush the surface of the pipeline to extract smaller items of debris from the pipeline. According to a further preferred feature of the embodiment said debris removal step further comprises causing a tertiary removal vehicle to travel along the interior of the pipeline and causing the tertiary removal vehicle to wash and vacuum fine debris and water from the pipeline.

According to a preferred feature of the invention said application step comprises causing the application vehicle to travel along the length of the pipeline and causing the application vehicle to applying the fresh lining composition to the locations at which the lining has been excised. According to one particular embodiment the lining composition is applied to a discrete location by spraying utilising a directional nozzle. According to an alternative embodiment the lining composition is applied around the internal circumference of the pipeline by the centrifugal application of the lining composition. According to a preferred feature of the embodiments the lining composition comprises a cementitious composition.

According to a preferred feature of the invention the method further comprises the delivery of lining composition to the application vehicle during the application of the lining composition to the pipeline. According to one embodiment the lining composition is delivered to the application vehicle by a delivery vehicle which is adapted to be able to travel through the pipeline and carry a quantity of lining composition to the application vehicle, said delivery vehicle having a conveying means adapted to be able to convey the lining composition from the delivery vehicle to the application vehicle.

Accordingly the invention also resides in a conveyance for use in the selective refurbishment of the internal cement lining of a pipeline according to the method described above, said conveyance comprising a plurality of vehicles capable of independently travelling along the pipeline for the purposes of inspection, excising damaged lining, removal of debris and application of a fresh lining composition, each of said vehicles being configured such that their centre of gravity when in use is below the central longitudinal axis of the pipeline and each of said vehicles being self powered and self propelled.

According to a preferred feature of the invention said conveyance means comprises a plurality of self propelled and self powered vehicles which comprise: an inspection vehicle for said inspection step; an excising vehicle for said excising step; at least one removal vehicle for said removal of debris step; and a least one application vehicle for said application step.

According to a preferred feature of the previous feature of the invention at least some of the vehicles are adapted to be operated remotely. According to one embodiment all of the vehicles are adapted to be operated remotely. According to an alternative embodiment at least one of the vehicles is adapted to be operated by an operator in-situ in the pipeline and incorporates controls operable by the operator to effect at least some of the operations of the vehicle. According to a feature of the alternative embodiment the at least one vehicle is provided with a support to enable the operator to be supported by the vehicle. According to an alternative feature of the embodiment the at least one vehicle is associate with an operator vehicle which is coupled to the at least one vehicle wherein the operator vehicle is provided with a support to enable the operator to be supported by the operator vehicle. According to a particular form the operator vehicle is provided with the controls.

According to a preferred form the inspection vehicle incorporates a viewing means which comprises an illumination means and a viewing means comprising at least one camera adapted to facilitate inspection of the lining of the pipeline remotely.

According to a further preferred feature of the invention the excising vehicle accommodates a nozzle which is supported to be capable of rotation about a longitudinal axis of said pipeline whereby said nozzle is adapted to be able to direct a stream of high pressured fluid onto the lining to remove the lining from the pipe interior. According to an embodiment of the invention the excising vehicle is associated with an umbilical incorporating a delivery conduit for said high pressure fluid. According to a further preferred feature of the invention the excising vehicle further comprises an illumination means and a viewing means comprising at least one camera to facilitate remote inspection of the location being subjected to the action of said steam of high pressure fluid. According to one preferred feature the high pressure stream of fluid incorporates abrasive particles. According to a further preferred feature of the invention the orientation of the stream to the surface of the pipeline can be adjusted. According to a further preferred feature of the previous feature the excising vehicle incorporates a second nozzle which is directed onto the lower portion of the pipeline forward of the vehicle, wherein the second nozzle generates a forwardly directed jet of fluid having a transverse extent.

According to a further preferred feature of the invention the debris removal vehicle is adapted to travel along the pipeline and collect the debris generated by the excising step from the pipeline wherein the vehicle is adapted to remove large and small items of debris from the pipeline. According to a preferred feature of the invention the debris removal vehicle comprises a plurality of vehicles comprising a primary vehicle adapted to remove the large items of debris from the pipeline and a secondary vehicle for removal of the smaller items from the pipeline. According to a particular embodiment the debris removal vehicle also comprises a tertiary vehicle for the removal of fine material from the pipeline. According to one embodiment the primary vehicle comprises a scooping means, a conveying means and a hopper said scooping means being adapted to scoop larger items of debris from the pipeline, the conveying means being adapted to convey the items from the scooping means to the hopper. According to the embodiment the secondary vehicle comprises a brushing means, a vacuum extraction means and a hopper, said brushing means being adapted to brush the lower surface of the pipeline, the vacuum extraction means being adapted to convey the fine materials and water to the hopper. According to the embodiment the tertiary vehicle comprises a washing means, a vacuum extraction means and a hopper, said washing means being adapted wash the fine materials from the surface of the pipeline, the vacuum extraction means being adapted to convey the fine materials and water to the hopper. According to an alternative embodiment the debris removal vehicle comprises a single vehicle incorporating scooping means, a brushing means, a washing means, a conveying means, a vacuum extraction means and a hopper, said scooping means being adapted to scoop larger items of debris from the pipeline, the conveying means adapted to convey the items to the hopper, the brushing means adapted to brush the lower surface of the pipeline, the washing means adapted to wash fine materials from the surface, of the pipeline, -the vacuum extraction means associated with the brushing means and washing means to convey materials dislodged by the brushing means and the washing means to the hopper.

According to a further preferred feature of the invention the application vehicle comprises a hopper adapted to accommodate a quantity of said lining composition, a pump means for pumping said lining composition and an outlet which is capable of directing said lining composition onto the surface of the pipeline. According to one embodiment a delivery means is provided between the hopper and the pump and the delivery means is adapted to deliver the lining composition to the pump. According to one embodiment the application vehicle includes an operator trolley which is adapted to accommodate an operator, wherein said outlet is supported from an operator trolley and is adapted to be controlled by the operator. According to a preferred embodiment of the invention the application vehicle is associated with a delivery vehicle having a hopper and a conveying means whereby said delivery vehicle can be brought into abutting relationship with the application vehicle whereby the conveying means can deliver lining composition from the hopper of the delivery vehicle to the hopper of the application vehicle.

According to a preferred feature of the invention the inspection vehicle and excising vehicle comprise a single vehicle.

The invention will be more fully understood in the light of the following description of several specific embodiments.

### BRIEF DESCRIPTION OF THE DRAWINGS

The description will be more fully understood in the light of the following drawings of which;

FIG. 1 is schematic side elevation of an above ground pipeline which has been prepared for the refurbishment procedure according to the first embodiment;

FIG. 2 is a schematic side elevation of the inspection vehicle according to the first embodiment;

FIG. 3 is a schematic side elevation of the excising vehicle according to the first embodiment;

FIG. 4 is a side elevation of the primary removal vehicle according to the first embodiment;

FIG. 5 is a side elevation of the secondary removal vehicle according to the first embodiment;

FIG. 6 is a side elevation of the tertiary removal according to the first embodiment;

FIG. 7 is a schematic side elevation of an application vehicle according to the first embodiment; and

FIG. 8 is a side elevation of a delivery vehicle according to the first embodiment.

### DETAILED DESCRIPTION OF SPECIFIC EMBODIMENTS

The first embodiment is directed to the refurbishment of an above ground lined, water pipeline. The embodiment has particular application to a pipeline which has an internal lining formed of a cementitious composition.

It is an object of the embodiment to provide a means whereby the damaged portions of the lining of a water pipeline can be selectively replaced as required.

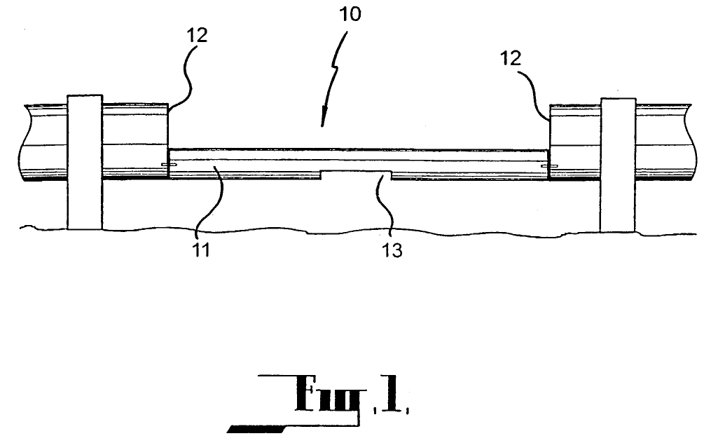

The method according to the embodiment comprises initially cutting a section from the length of pipeline as, shown at FIG. 1 to create a gap 10 between two opposed ends of the pipeline. In practice it has been found appropriate to create a number of gaps 10 of the form as described above and shown at FIG. 1, at spacings of approximately three to four hundred metres apart, whereby the various stages of the refurbishment process (i.e. inspection, excising, removal of debris and application) can be effected simultaneously at different locations along the pipeline.

The gap is filled by a tray 11 which is intended to provide a continuation of the lower portion of the pipeline between the exposed ends 12 of the pipeline which have been created by the creation of the gap. The tray is adapted at each end to be supported from each end 12 of the pipeline. In addition the tray is provided at an intermediate position along its length with an opening in its lower face. Once the tray 11 has been located in position across the gap defined between the two ends of the pipeline a conveyance is then used for the purposes of inspection of the lining of the pipeline, excising damaged portions of the lining, removal of the debris generated by the excising process and application of fresh lining to the excised portions. The conveyance comprises a number of separate vehicles which are capable of travelling along the length of the pipeline. As a result of the creation of a number of gaps 10 the vehicles are only required to travel the length of the pipeline between the adjacent gaps.

The vehicles which comprise the conveyance of the embodiment comprise:

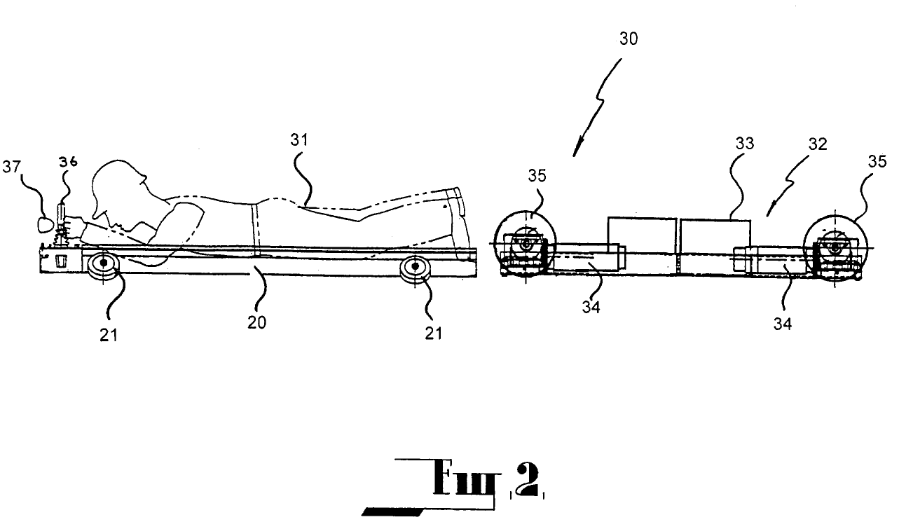

an inspection vehicle 30 (shown at FIG. 2);

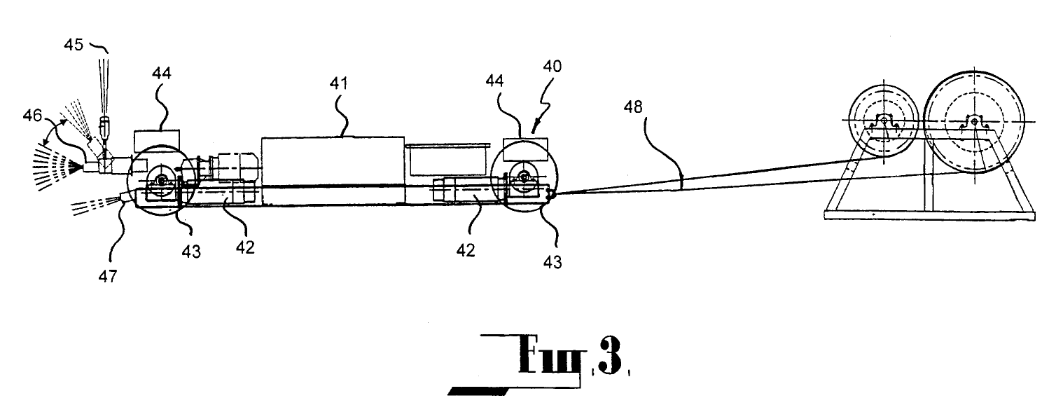

an excising vehicle 40 (shown at FIG. 3);

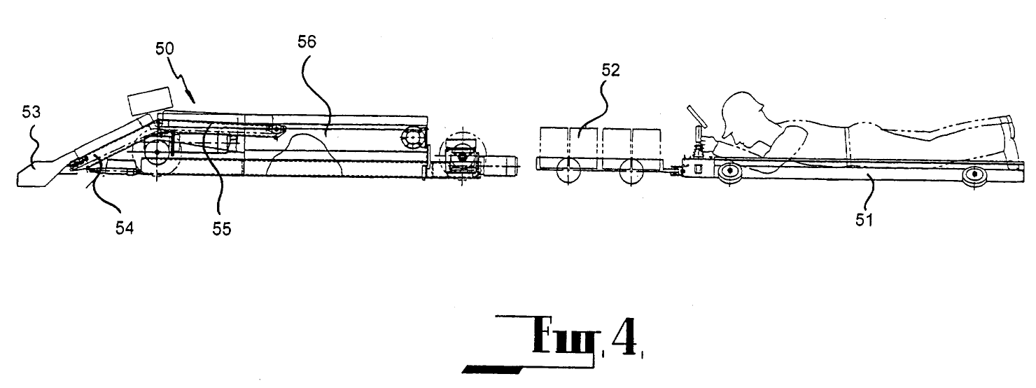

a primary removal vehicle 50 (shown at FIG. 4);

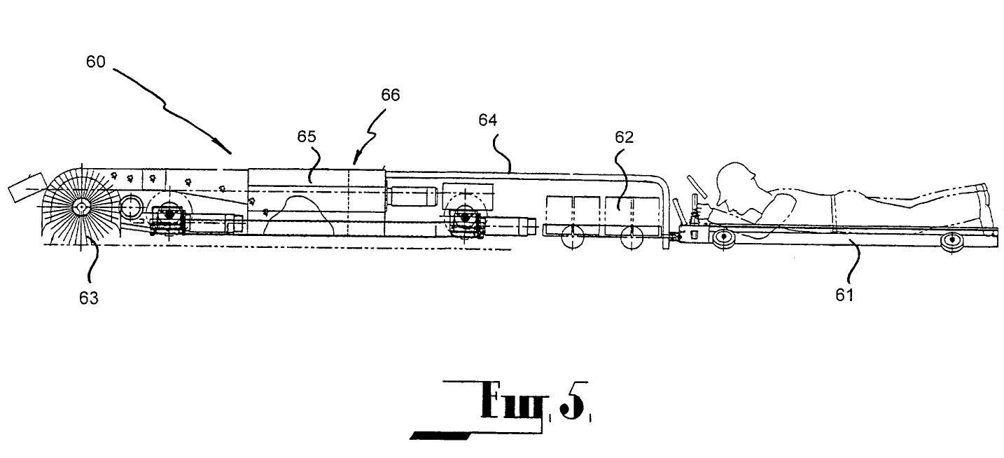

a secondary removal vehicle 60 (shown at FIG. 5);

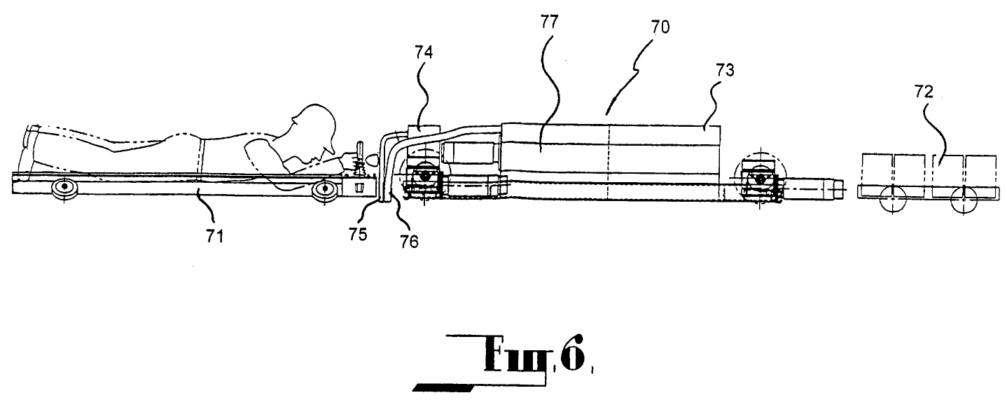

a tertiary removal vehicle 70 (shown at FIG. 6);

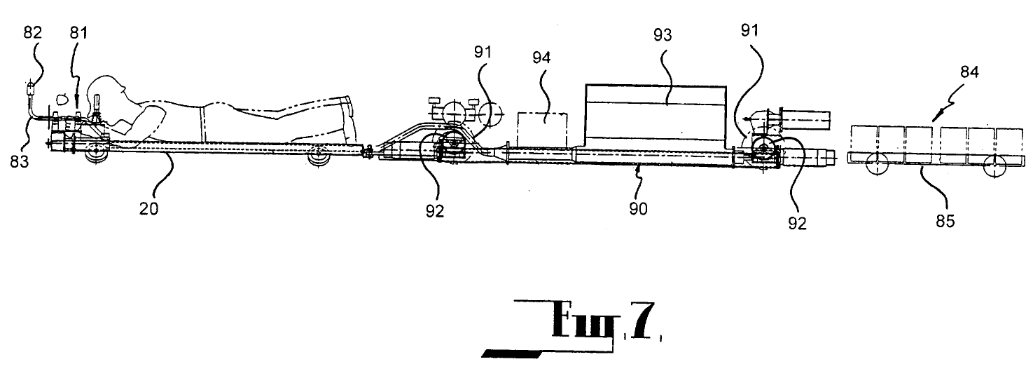

an application vehicle comprising an operator trolley 80 a hopper vehicle 90 and a battery vehicle 84 (shown at FIG. 7); and

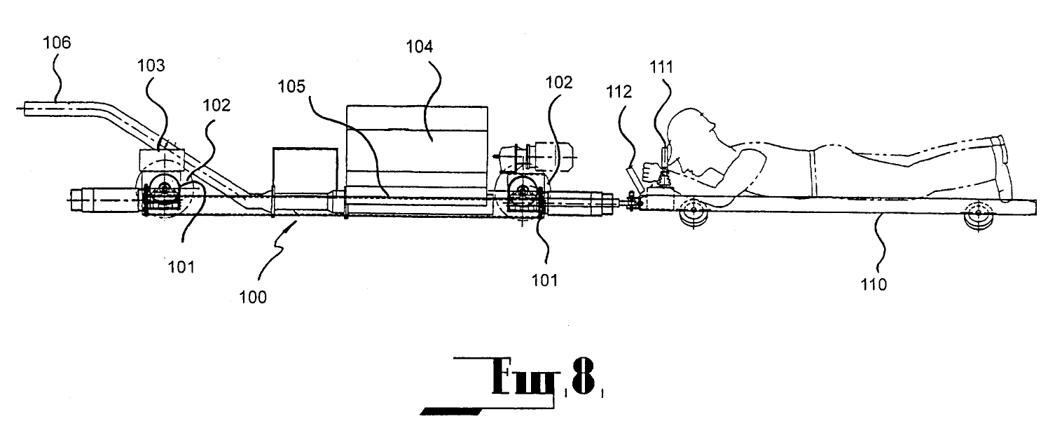

a delivery vehicle 100 (shown at FIG. 8).

Each of the vehicles comprise a lower chassis which is provided with a set of wheels. In addition each of the vehicles are configured such that the centre of gravity of the vehicle, when in use (including conditions when they accommodate an occupant and/or are carrying a load), is lower than the central longitudinal axis of the pipeline. It is by this location of the centre of gravity that the vehicles are prevented from spiralling around the walls of the pipeline and will remain in the lower portion of the pipeline.

In addition each of the vehicles are movable independently along the length of the pipeline and are independently powered and as a result they do not require utilisation of an external power source in order to effect the movement along the pipeline. This is effected by each vehicle having a set of driven wheels which are driven from electric motors which are operated from a control means which may be remote from the vehicle and/or may be provided on the vehicle. According to the embodiment the front wheels of a vehicle are driven from one electric motor while the rear wheels are driven from another electric motor. The power for each of the drive motors is derived from a battery pack which can be supported from the vehicle. If desired the battery pack may be carried by a separate vehicle (i.e. battery vehicles 52 of FIG. 4, 62 of FIG. 5, 72 of FIG. 6 and 84 of FIG. 7) where there is insufficient space available on a particular functioning vehicle or it is inappropriate to locate the battery pack on a functioning vehicle given the function of the functioning vehicle.

In some instances the vehicle may comprise or incorporate an operator trolley which is supported from a set of non-driven wheels and has a chassis which is configured to provide a platform which will accommodate an operator. In each case the operator trolley is coupled to a the respective functional vehicle which has a chassis which is supported by a set of driven wheels which are associated with drive motors which are drivingly connected to the drive wheels. The functional vehicle provides the motive force to enable the operator trolley to travel through the pipeline as well as all specialist equipment to meet the functional requirements of the respective vehicle. In each case the operator trolley is provide with the appropriate controls to enable the operator to control the movement of the operator trolley through the pipeline and the functions of the vehicle with which the trolley is associated. In some instances the operator trolley may be provided with a visual display unit screen, an illumination means and a viewing means in the form of one or more cameras to facilitate the control of the vehicle with which the operator trolley is associated.

The method according to the embodiment initially comprises inspecting the length of pipeline between adjacent gaps 10 in the pipeline. This is effected by utilisation of an inspection vehicle 30 as shown at FIG. 2 which comprises an operator trolley 20, which is supported from a set of non-driven wheels 21 and has a chassis which is configured to provide a platform which will accommodate an operator 31. The operator trolley is coupled to a traction trolley 32 which has a chassis which supports a battery pack and is supported by a set of drive wheels 35 which are associated with drive motors 34 which are drivingly connected to the drive wheels 35. The traction trolley 32 provides the motive force to enable the inspection vehicle to travel through the pipeline. The forward end of the operator trolley is provided with a hand control 36 which can be manipulated by the operator 31 to effect the controlled movement of the inspection vehicle along the pipeline. In addition the operator trolley 30 is associated with an illumination means which is able to illuminate the walls of the pipeline to facilitate the visual inspection of the pipeline by the occupant 31. In addition the operator trolley is associated with a communication means. If desired the inspection vehicle can include a viewing means in the form of one or more video cameras which can be used to provide a record of the state of the pipeline prior to its refurbishment. In addition according to the embodiment the operator 31 when inspecting the pipeline will physically mark the locations of the damaged portions of the pipeline for later identification during the excising operation.

Once the length of pipeline between two adjacent gaps 10 has been inspected and the damage or degradation to the lining at the various locations along the pipeline have been identified and marked it is then necessary to excise from the lining the damaged or degraded portions of the lining at each location. This is effected by utilisation of an excising vehicle as shown at FIG. 3. The excising vehicle is operated remotely such that is able to move independently along the length of the pipeline and as shown at FIG. 3 accommodates a battery pack 41 and a set of drive motors 42 which are drivingly connected to the wheels 43 of the vehicle 40. In addition the forward end of the vehicle 40 is provided with an illumination means in the form of suitable lights and a set of video cameras which are accommodated within a housing 44 and which facilitate the visual inspection of the lining in order to control, monitor and record the excising step. In addition the forward end of the excising vehicle accommodates a excising nozzle 45 which is capable of rotating about a longitudinal axis of the vehicle and which is directed generally radially. The excising nozzle 45 is intended to effect the removal of the lining at the locations identified by the inspection step and is capable of producing a jet of high pressure fluid which if desired can incorporate abrasive particulate materials to enhance its action. In addition the excising vehicle is provided with a washing nozzle 46 which is directed forwardly and axially from the forward end of the excising vehicle 40 and which can be adjusted to be directed obliquely at the surface of the pipeline. The washing nozzle 46 produces a spray which is capable of washing the surface of the pipeline. The forward end of the excising vehicle 40 also accommodates a plurality of debris clearance nozzles 47 which are directed forwardly and downwardly such that it they are directed onto the surface of the pipeline ahead of the excising vehicle. The debris clearance nozzles 47 jointly produce a high pressure spray having a lateral dimension such that it is able to impact upon debris generated by the excising process and drive it forwardly of the excising vehicle as the excising vehicle moves along the length of the pipeline.

The excising vehicle 40 is associated with a high pressure fluid delivery conduit for the delivery of fluid to the excising nozzle 45, the washing nozzle 46 and the debris clearance nozzles 47. The excising vehicle 40 is also associated with an umbilical which accommodates electrical cables for controlling all of the functions of the excising vehicle and transmitting the signals from the camera and any other sensors associated with the vehicle to the control room.

In use the excising vehicle is caused to travel along the pipeline and when it reaches a previously identified location of damaged lining, the excising nozzle 45 is moved to a position such that it is directed towards the damaged portion and a jet of high stream fluid is then directed towards the damaged portion in order to remove the damaged portion of lining. During this operation the action of the excising nozzle 45 can be monitored through the camera to ensure that the excising action is adequate. In addition as the excising vehicle 40 moves along the length of the pipeline the surface of the pipeline is washed by the washing nozzle 46 to at least partially remove slimes and/or loose particles from the surface. In addition the debris clearance head 47 serves to drive any debris which is generated by the excising operation forward of the excising vehicle 40 such that the debris does not inhibit the movement of the excising vehicle along the pipeline. If desired the excising function, the washing function and the debris clearance function of the excising vehicle may be effected in unison or independently as separate functions. In addition in the event that the amount of debris in the pipeline inhibits the progress of the excising vehicle through the pipeline it may be necessary to extract the excising vehicle from the pipeline and effect the removal of the debris from the pipeline by at least partial utilisation of one or more of the debris removal vehicles as described below.

Once the excising step has been completed or during the excising step it will become necessary to remove from the pipeline the debris which has been generated by the excising step. This is effected by use of at least one of the debris removal vehicles which are shown at FIGS. 4, 5 and 6.

The debris removal vehicles comprise a primary removal vehicle 50 as shown at FIG. 4 which is intended to remove large items of debris from the pipeline, a secondary removal vehicle 60 as shown at FIG. 5 which is intended to brush the lower surface of the pipeline to remove smaller items and a tertiary removal vehicle 70 as shown at FIG. 6 which enables the collection of fine materials and residual water which has been not collected by the primary and secondary removal vehicles. Each of the removal vehicles is associated with an operator trolley 51, 61 and 71 which are of a similar form to the operator trolley used with the inspection vehicle. Each operator trolley. 51, 61 and 71 is able to accommodate an operator and is provided with a hand control whereby the operator is able to effect all of the functions of the respective vehicle. In addition each removal vehicle is associated with a battery pack 52, 62 and 72 respectively which is supported upon its own wheeled chassis and which powers the drive motors for the wheels of the primary, secondary and tertiary removal vehicles 50, 60 and 70 respectively as well as the motors associated with the conveying means (when present) and any other ancillary apparatus.

The primary removal vehicle 50 is provided with a forwardly extending scoop 53 which is supported upon a forwardly extending frame 54 which is pivotally supported from the forward end of the main body of the primary removal vehicle 50. A hydraulic ram or like extension means is provided between the chassis and the frame 54 in order to control the elevation of the scoop 53 from the lower surface of the pipeline. In addition the scoop 53 is associated with a conveyor which comprises an endless belt 55 which extends along the length of the forwardly extending frame and for a portion of the length of the body of the primary removal vehicle 50 to terminate at a hopper 56 provided in the primary removal vehicle 50. In use the primary removal vehicle is moved along the pipeline with the scoop 53 in close engagement with the lower face of the pipeline whereby large items of debris are picked up by the scoop and carried to the conveyor whereby they are then conveyed to the debris hopper. The hopper 56 which is provided in the primary removal vehicle 50 is provided with at least one closure on its lower face whereby the closure may be selectively opened to permit the contents of the hopper to be dumped. This is effected when the primary removal vehicle 50 is supported upon the tray 11 provided in the gap 10 between the two ends of the pipeline 12 whereby the closure is located directly over the opening 13 provided in the tray in order that the contents of the hopper are deposited onto the ground below the tray.

The secondary removal vehicle 60 as shown at FIG. 5 is provided at its forward end with a brushing unit comprising a brush 63 having a profile corresponding to the profile of the lower portion of the pipe and which by its action is able to deliver debris from the floor of the pipeline to a hopper 65 provided within the body of the secondary removal vehicle 60. The secondary removal vehicle 60 is also provided with a vacuum extraction means whereby the smaller debris not collected by the brush is sucked through a duct 64 to a second hopper 66 provided within the body of the secondary removal vehicle. The hoppers 65 and 66 are also provided with at least one closure on their lower face to enable the contents of the hoppers to be deposited from the hoppers when the secondary removal vehicle is located on the tray 11 located in the gap 10 between two ends 12 of the pipeline.

The tertiary removal vehicle 70 as shown at FIG. 6 comprises a washing and vacuum extraction unit whereby the excised portions of the pipe can be finally cleaned. The vehicle comprises a water reservoir 73 which is connected, through a pump 74 to an outlet nozzle 75 which is intended to direct a spray of water into the lower portion of the pipe. The outlet nozzle 75 is associated with a vacuum inlet 76 which is connected to a hopper 77 whereby the water and entrained debris collecting in the lower portion of the pipe can be picked up and deposited into the hopper 76 supported on the vehicle. The hopper 77 is provided with at least one closure in its lower face whereby the hopper can be opened to enable the contents to be deposited from the hopper when the tertiary removal vehicle is supported upon the tray 11 in the gap 10 between the two ends 12 of the pipe.

As a result of the utilisation of the three debris removal vehicles the surface of the pipe can be thoroughly cleaned subsequent to the excising action and in preparation for the application step.

The application step comprises the selective application of a fresh lining composition to the locations at which the pre-existing lining has bee excised from the pipeline by the excising step. In order to replace the damaged lining an application vehicle of the form as shown as FIG. 7 is utilised. The application vehicle comprises an operator trolley 80 which is intended to accommodate an occupant and which has a hand control 81 to facilitate the controlled movement of the application vehicle along the pipeline. In addition the operator trolley 80 is provided with an application means for the application of a lining composition onto the wall of the pipe. The application means can comprise a spray nozzle 82 supported upon on a radial arm 83 which is able to rotate about an longitudinal axis of the pipeline and which can be controlled in its movement and operation by the operator to effect a localised application of the lining composition to the pipeline. Where the application step involves the wholesale application of a lining composition to a large area the application means may comprise a spinner head which is caused to rotate about a longitudinal axis and which has an outlet from which the lining composition is delivered to be thrown centrifugally against the internal face of the pipeline to effect a spray pattern around the inner circumference of the pipeline.

The application vehicle also comprises a hopper vehicle 90 which is supported in the pipeline by a set of driven wheels 91 which are associated with drive motors. The hopper vehicle 90 accommodates a hopper for the lining composition which is connected to the application means through a delivery means in the form of an auger and through a pump for the delivery of the lining composition to the application means. The application vehicle is also associated with a battery vehicle 84 which is supported upon a wheeled chassis 85 and which is towed behind the hopper vehicle 90.

The application vehicle is also associated with a delivery vehicle 100 whereby the hopper 93 of the application vehicle can be refilled with the lining composition. The delivery vehicle 100 is associated with an operator trolley 110 which accommodates an occupant who is able to control all of the functions of the delivery vehicle. In addition the operator trolley 110 is provided with a visual display unit screen which is associated with a camera and lighting means 103 provided at the forward end to the vehicle 100 whereby the operator is able to determine the location of the delivery relative to the application vehicle when approaching the application vehicle.

The delivery vehicle 100 comprises a hopper 104 which is intended accommodate the lining composition. The hopper 104 is connected to a pump through a feed auger 105 which is connected to a delivery pipe 106 which extends forwardly from the delivery such that when the delivery vehicle is in close abutment with the rearward end of the application vehicle the delivery pipe 106 is located to enable the lining composition being delivered from the delivery pipe will be deposited into the hopper 93 of the application vehicle.

The delivery vehicle 100 enables the application vehicle to be used continuously in applying lining composition to the excised portions of the lining at the locations at which the lining has been excised without the need to return to the most adjacent gap 10 to be refilled with lining composition.

The embodiment according to the invention provides a means whereby the life of an existing lined pipeline can be extended without the need to effect wholesale replacement of the pipeline or complete replacement of lining of that pipeline which may include sound lining. Rather the method according to the embodiment involves the identification of those portions of the pipeline which have suffered significant deterioration, excising of those portions of the lining from the existing lining and then replacement of the excised portion with fresh lining composition.

According to a second embodiment of the invention the inspection step and the excising step are effected remotely by the use of the same vehicle. In the case of the second embodiment the camera of the excising vehicle of the first embodiment is used to remotely inspect the state of the lining as the excising vehicle travels along the pipeline. On a portion of the lining being identified as being inadequate the excising nozzle is activated to remove the lining so identified. In the case of the second embodiment the observation by the camera may be supplemented by other sensing means to assess the quality of the lining in order to assess its adequacy. In addition the state of the pipeline before and/or after the excising action may be logged at the control station.

According to a second embodiment of the invention the removal vehicle may comprise a single vehicle which is able to achieve each of the functions of the primary, secondary and tertiary removal vehicles of the first embodiment.

According to a third embodiment of the invention the application vehicle may comprise a single vehicle which incorporates the combined features of the forward and rearward vehicles of the first embodiment.

According to a third embodiment the invention is applied to the selective refurbishment of the lining of an underground pipeline whereby the pipeline is exposed at spaced positions to enable a gap of the form described above in relation to the first embodiment to be created in the pipeline at each position and the pipeline to be treated in the manner described above in relation to each of the above embodiments. According to an alternative embodiment openings are formed at each position rather than gaps.

Throughout the specification, unless the context requires otherwise, the word “comprise” or variations such as “comprises” or “comprising”, will be understood to imply the inclusion of a stated integer or group of integers but not the exclusion of any other integer or group of integers.

It should be appreciated that the scope of the present invention need not be limited to the particular scope of the embodiments described above.

The claims defining the invention are as follows:

1. A method of selectively repairing the lining of a lined pipeline, said method involving the utilisation of a conveyance adapted to be receivable within the pipeline, said conveyance being adapted to be able to travel through the pipeline, said conveyance comprising an inspection means, an excising means, a debris removal means and an application means, said method comprising introducing said conveyance into the pipeline, said method further comprising: an inspection step which comprises causing the conveyance to travel along the length of the pipeline; inspecting the surface of the lining and identifying and locating damaged portions of the lining at locations along the pipeline; an excising step comprising moving said conveyance along the pipeline and at the locations identified by the inspection step excising the damaged portions of the lining from the pipeline; a debris removal step comprising causing said conveyance to travel along said length of the pipeline to remove the debris left in the pipeline by the excising step; and an application step comprising causing said conveyance to travel along the said length of the pipeline and applying a fresh lining composition onto the lining to replace the excised portions of lining removed by the excising step.

2. A method of selectively repairing the lining of a lined pipeline as claimed at claim 1 which further comprises cutting a length of pipe from the pipeline at a position to provide a gap in the pipeline at the location, locating a support tray between the opposed ends of the remaining pipeline to span the lower portion of the gap and to provide a continuation of the lower surface of the pipeline across the gap.

3. A method of selectively repairing the lining of a lined pipeline as claimed at claim 2 wherein the pipeline is above the ground at the position.

4. A method of selectively repairing the lining of a lined pipeline as claimed at claim 2 wherein the pipeline is buried at the position and the method further comprises exposing the length of pipe at the position prior to the length of pipe being cut from the pipeline.

5. A method of selectively repairing the lining of a lined pipeline as claimed at any one of the preceding claims wherein said conveyance means comprises a plurality of self propelled and self powered vehicles which comprise: at least one inspection vehicle for said inspection step; an excising vehicle for said excising step; at least one removal vehicle for said removal of debris step and at least one application vehicle for said application step.

6. A method of selectively repairing the lining of a lined pipeline as claimed at claim 5 wherein at least some of the vehicles are operated remotely.

7. A method of selectively repairing the lining of a lined pipeline as claimed at claim 5 or claim 6 wherein all of the vehicles operated remotely.

8. A method of selectively repairing the lining of a lined pipeline as claimed at claim 5 or 6 wherein at least one of the vehicles is provided with a support to enable the operator to be supported by the vehicle and is adapted to be operated by an operator in-situ in the pipeline and the vehicle incorporates controls operable by the operator to effect at least some of the operations of the vehicle.

9. A method of selectively repairing the lining of a lined pipeline as claimed at claim 8 wherein the at least one vehicle is associated with an operator trolley which provides said support to enable the operator to be supported by the vehicle and said controls.

10. A method of selectively repairing the lining of a lined pipeline as claimed at claim 8 wherein the at least one vehicle is associated with an operator vehicle which is coupled to the at least one vehicle wherein the operator vehicle is provided with a support to enable the operator to be supported by the operator vehicle.

11. A method of selectively repairing the lining of a lined pipeline as claimed at claim 10 wherein the operator vehicle is provided with the controls.

12. A method of selectively repairing the lining of a lined pipeline as claimed at any one of the preceding claims wherein said inspection step comprises causing the inspection vehicle to travel along the interior of the pipeline and during such travel inspecting the lining within the pipeline, identifying locations of damaged or deteriorated lining.

13. A method of selectively repairing the lining of a lined pipeline as claimed at claim 12 wherein the inspection step is conducted remotely and a log is maintained to record the position of said locations in the pipeline and the type of damage.

14. A method of selectively repairing the lining of a lined pipeline as claimed at claim 12 wherein the inspection step involves utilisation of an operator supported on the inspection vehicle, said operator being skilled in identifying the damaged or deteriorated portions of the lining, said identifying of damaged or deteriorated lining including the operator providing markings on the lining to indicate the locations.

15. A method of selectively repairing the lining of a lined pipeline as claimed at any one of the preceding claims wherein said excising step comprises utilisation of a nozzle connected to a source of high pressure fluid whereby said nozzle is able to be moved to direct a jet of said high pressure fluid over the surface if the lining, said remotely controlled nozzle being supported from the excising vehicle, said method causing the excising vehicle to travel along the interior of the pipeline and during such travel causing the nozzle to direct said jet of said high pressure fluid onto the lining at the locations in order to remove the lining at said locations.

16. A method of selectively repairing the lining of a lined pipeline as claimed at claim 15 wherein the excising vehicle is associated with a remote control station which is provided with a display means and controls to enable the remote operation of the vehicle and the nozzle from the control station by an operator.

17. A method of selectively repairing the lining of a lined pipeline as claimed at any one of the preceding claims wherein said debris removal step comprises causing a removal vehicle to travel along the interior of the pipeline and causing the removal vehicle to collect debris from the interior of the pipeline as it travels.

18. A method of selectively repairing the lining of a lined pipeline as claimed at claim 17 wherein the removal step initially comprises causing a primary removal vehicle to travel along the interior of the pipeline, scooping said large items from the pipeline as it travels along the pipeline and conveying the items into a hopper associated with the primary removal vehicle.

19. A method of selectively repairing the lining of a lined pipeline as claimed at claim 17 or 18 wherein said debris removal step further comprises causing a secondary removal vehicle to travel along the interior of the pipeline ant causing the secondary removal vehicle to brush the surface of the pipeline to extract smaller items of debris from the pipeline.

20. A method of selectively repairing the lining of a lined pipeline as claimed at claim 17, 18 or 19 wherein said debris removal step further comprises causing a tertiary removal vehicle to travel along the interior of the pipeline and causing the tertiary removal vehicle to wash and vacuum fine debris and water from the pipeline.

21. A method of selectively repairing the lining of a lined pipeline as claimed at any one of the preceding claims wherein said application step comprises causing the application vehicle to travel along the length of the pipeline and causing the application vehicle to applying the fresh lining composition to the locations at which the lining has been excised.

22. A method of selectively repairing the lining of a lined pipeline as claimed at claim 21 wherein the lining composition is applied to a location by spraying utilising a directional nozzle.

23. A method of selectively repairing the lining of a lined pipeline as claimed at claim 21 wherein the lining composition is applied around the interior circumference of the pipeline by a centrifugal application of the lining composition.

24. A method of selectively repairing the lining of a lined pipeline as claimed at claim 21 or 22 or 23 wherein the method further comprises the delivery of lining composition to the application vehicle during the application of the lining composition to the pipeline.

25. A method of selectively repairing the lining of a lined pipeline as claimed at claim 24 wherein the lining composition is delivered to the application vehicle by a delivery vehicle which is adapted to be able to travel through the pipeline and carry a quantity of lining composition to the application vehicle, said delivery vehicle having a conveying means adapted to be able to convey the lining composition from the delivery vehicle to the application vehicle.

26. A method of selectively repairing the lining of a lined pipeline as claimed at any one of the preceding claims wherein the lining composition comprises a cementitious composition.

27. A method of selectively repairing the lining of a lined pipeline substantially as herein described.

28. A conveyance for use in the selective refurbishment of the lining of a lined pipeline according to the method described above, said conveyance comprising a plurality of vehicles capable of independently travelling along the pipeline for the purposes of inspection, excising damaged lining, removal of debris and application of a fresh lining composition, each of said vehicles being configured such that their centre of gravity when in use is below the central longitudinal axis of the pipeline and each of said vehicles being self powered and self propelled.

29. A conveyance for use in the selective refurbishment of the lining of a lined pipeline as claimed at claim 28 wherein a plurality of self propelled and self powered vehicles which comprise: an inspection vehicle for said inspection step; an excising vehicle for said excising step; at least one removal vehicle for said removal of debris step; and at least one application vehicle for said application step.

30. A conveyance for use in the selective refurbishment of the lining of a lined pipeline as claimed at claim 29 wherein at least some of the vehicles are adapted to be operated remotely.

31. A conveyance for use in the selective refurbishment of the lining of a lined pipeline as claimed at claim 29 and 30 wherein all of the vehicles are adapted to be operated remotely.

32. A conveyance for use in the selective refurbishment of the lining of a lined pipeline as claimed at claim 29 and 30 wherein at least one of the vehicles is provided with a support to enable the operator to be supported by the vehicle and is adapted to be operated by an operator in-situ in the pipeline and the vehicle incorporates controls operable by the operator to effect at least some of the operations of the vehicle.

33. A conveyance for use in the selective refurbishment of the lining of a lined pipeline as claimed at claim 32 wherein the at least one vehicle is associated with an operator trolley which provides said support to enable the operator to be supported by the vehicle and said controls.

34. A conveyance for use in the selective refurbishment of the lining of a lined pipeline as claimed at claim 32 wherein the at least one vehicle is associated with an operator vehicle which is coupled to the at least one vehicle wherein the operator vehicle is provided with a support to enable the operator to be supported by the operator vehicle.

35. A conveyance for use in the selective refurbishment of the lining of a lined pipeline as claimed at claim 34 wherein the operator vehicle is provided with the controls.

36. A conveyance for use in the selective refurbishment of the lining of a lined pipeline as claimed at any one of claims 29 to 35 wherein the inspection vehicle incorporates an illumination means and a viewing means which comprises at least one camera adapted to facilitate inspection of the lining of the pipeline remotely.

37. A conveyance for use in the selective refurbishment of the lining of a lined pipeline as claimed at any one of claims 29 to 36 wherein the excising vehicle accommodates a nozzle which is supported to be capable of rotation about a longitudinal axis of said pipeline whereby said nozzle is adapted to be able to direct a stream of high pressured fluid onto the lining to remove the lining from the pipe interior.

38. A conveyance for use in the selective refurbishment of the lining of a lined pipeline as claimed at claim 37 wherein the excising vehicle is associated with a remote control station which is provided with a display means and controls to enable the remote operation of the vehicle and the nozzle from the control station by an operator.

39. A conveyance for use in the selective refurbishment of the lining of a lined pipeline as claimed at claim 38 wherein the excising vehicle is associated with a delivery conduit for said high pressure fluid and an umbilical providing connection between the control station and the excising vehicle.

40. A conveyance for use in the selective refurbishment of the lining of a lined pipeline as claimed at claim 37 or 38 or 39 wherein the excising vehicle further comprises an illumination means and a viewing means comprising at least one camera to facilitate remote inspection of the location being subjected to the action of said steam of high pressure fluid.

41. A conveyance for use in the selective refurbishment of the lining of a lined pipeline as claimed at claim 37 or 38 or 39 or 40 wherein the high pressure stream of fluid incorporates abrasive particles.

42. A conveyance for use in the selective refurbishment of the lining of a lined pipeline as claimed at claim 37 or 38 or 39 or 40 or 41 wherein the orientation of the stream to the surface of the pipeline can be adjusted to effect various degrees of wash.

43. A conveyance for use in the selective refurbishment of the lining of a lined pipeline as claimed at claim 37 or 38 or 39 or 40 or 41 or 42 wherein the excising vehicle incorporates a second nozzle which is directed onto the lower portion of the pipeline forward of the vehicle, wherein the second nozzle generates a jet of fluid having a transverse extent.

44. A conveyance for use in the selective refurbishment of the lining of a lined pipeline as claimed at any one of claims 29 to 43 wherein the debris removal vehicle is adapted to travel along the pipeline and collect the debris generated by the excising step from the pipeline wherein the vehicle is adapted to remove large and small items of debris and/or water from the pipeline.

45. A conveyance for use in the selective refurbishment of the lining of a lined pipeline as claimed at claim 44 wherein the debris removal vehicle comprises a plurality of vehicles comprising a primary removal vehicle adapted to remove the large items of debris from the pipeline and a secondary removal vehicle for removal of the smaller items and/or water from the pipeline.

46. A conveyance for use in the selective refurbishment of the lining of a lined pipeline as claimed at claim 45 wherein the debris removal vehicle also comprises a tertiary removal vehicle for the removal of fine material and/or water from the pipeline.

47. A conveyance for use in the selective refurbishment of the lining of a lined pipeline as claimed at claim 45 or 46 wherein the primary removal vehicle comprises a scooping means, a conveying means and a hopper said scooping means being adapted to scoop larger items of debris from the pipeline, the conveying means being adapted to convey the items from the scooping means to the hopper.

48. A conveyance for use in the selective refurbishment of the lining of a lined pipeline as claimed at claim 45 or 46 or 47 wherein the secondary removal vehicle comprises a brushing means, a vacuum extraction means and a hopper, said brushing means being adapted to brush the lower surface of the pipeline, the vacuum extraction means being adapted to convey the debris dislodged by the brush and/or residual water to the hopper.

49. A conveyance for use in the selective refurbishment of the lining of a lined pipeline as claimed at claim 46 and any one of claims 47 and 48 as dependant from claim 44 wherein the tertiary removal vehicle comprises a washing means, a vacuum extraction means and a hopper, said washing means being adapted to wash debris from the surface of the pipeline, the vacuum extraction means being adapted to convey the debris and/or water to the hopper.

50. A conveyance for use in the selective refurbishment of the lining of a lined pipeline as claimed at any one of claims 29 to 44 wherein the debris removal vehicle comprises a single vehicle incorporating scooping means, a brushing means, a washing means, a conveying means, a vacuum extraction means and a hopper, said scooping means being adapted to scoop larger items of debris from the pipeline, the conveying means adapted to convey the items to the hopper, the brushing means adapted to brush the lower surface of the pipeline, the washing means adapted to wash fine materials from the surface of the pipeline, the vacuum extraction means associated with the brushing means and washing means to convey materials dislodged by the brushing means and the washing means to the hopper.

51. A conveyance for use in the selective refurbishment of the lining of a lined pipeline as claimed at any one of claims 29 to 50 wherein the application vehicle comprises a hopper adapted to accommodate a quantity of said lining composition, a pump means for pumping said lining composition, an outlet which is capable of directing said lining composition onto the surface of the pipeline.

52. A conveyance for use in the selective refurbishment of the lining of a lined pipeline as claimed at claim 51 wherein a delivery means is provided between the hopper and the pump and the delivery means is adapted to deliver the lining composition to the pump.

53. A conveyance for use in the selective refurbishment of the lining of a lined pipeline as claimed at claim 51 or 53 wherein the application vehicle is associated with a delivery vehicle having a hopper and a conveying means whereby said delivery vehicle can be brought into abutting relationship with the fourth vehicle whereby the conveying means can deliver lining composition from the hopper of the delivery vehicle to the hopper of the application vehicle.

54. A conveyance for use in the selective refurbishment of the lining of a lined pipeline as claimed at claim 51 or 52 or 53 wherein the application vehicle includes an operator trolley which is adapted to accommodate an operator, wherein said outlet is supported from an operator trolley and is adapted to be controlled by the operator.

55. A conveyance for use in the selective refurbishment of the lining of a lined pipeline as claimed at any one of claims 29 to 54 wherein the inspection vehicle and excising vehicle comprise a single vehicle.

56. A conveyance for use in the selective refurbishment of the lining of a lined pipeline substantially as herein described.
